(19) United States
(12) Patent Application Publication
(10) Pub. No.: US 2013/0106700 A1
(43) Pub. Date: May 2, 2013

(54) ELECTRONIC APPARATUS AND INPUT METHOD

(71) Applicants: Chikashi SUGIURA, Hamura-shi (JP); Yusaku KIKUGAWA, Ome-shi (JP)

(72) Inventors: Chikashi SUGIURA, Hamura-shi (JP); Yusaku KIKUGAWA, Ome-shi (JP)

(73) Assignee: KABUSHIKI KAISHA TOSHIBA, Tokyo (JP)

(21) Appl. No.: 13/598,458

(22) Filed: Aug. 29, 2012

(30) Foreign Application Priority Data
Nov. 2, 2011 (JP) 2011-241059

(51) Int. Cl. G06F 3/02

(52) U.S. Cl. 345/168

(57) ABSTRACT

According to one embodiment, an input control module determines, responding to release of a contact state of one of a plurality of first positions on a touch-screen display, which are put in contact with external objects, whether a contact time from when the external object is put in contact with the one of the plurality of first positions to when the contact state of the one of the plurality of first positions is released is shorter than a threshold time. The input control module executes an input process of inputting a key code associated with one of a plurality of first keys which corresponds to the one of the first positions, when the contact time is shorter than the threshold time.

### CROSS-REFERENCE TO RELATED APPLICATIONS

This application is based upon and claims the benefit of priority from prior Japanese Patent Application No. 2011-241059, filed Nov. 2, 2011; the entire contents of which are incorporated herein by reference.

### FIELD

Embodiments described herein relate generally to an electronic apparatus including a touch-panel display, and an input method which is applied to the electronic apparatus.

### BACKGROUND

In recent years, various types of portable personal computers, such as a notebook-type portable personal computer, have been developed. Most of these types of portable personal computers include keyboards serving as input devices. In addition, recently, in order to support key input by a user, there has been developed a system using a virtual keyboard (software keyboard) which is displayed on a touch-screen display.

By touching an arbitrary key on the virtual keyboard by a finger or a pen, the user can input a key code corresponding to this key.

In addition, among the electronic apparatuses including touch-screen displays or touch pads, there is known an electronic apparatus having a contact feedback function. The contact feedback function is a function for giving to the user, when the user's finger, for instance, has been put in contact with the touch-screen display or touch pad, the same sensation as is given when the user operates a hardware button.

In the meantime, recently, in order to make it easy to visually recognize various graphic contents such as a button, a menu, a document or an image, an electronic apparatus including a touch-screen display of a relatively large size has been developed. In this electronic apparatus, the virtual keyboard with such a large size as to enable an operation by both hands can be displayed on the touch-screen display.

In the case of using a hardware keyboard, the user can perform a type input operation in the state in which the user places the fingers of both hands on some keys corresponding to the home position. For example, by putting the fingers in contact with some keys corresponding to the home position, the user can perform a so-called touch-typing operation (a type input operation without viewing the keyboard).

However, in the case of an ordinary virtual keyboard, when the user's finger has come in contact with a certain position on the touch-screen display, the key code of the key corresponding to the position of contact is input. Thus, unlike the case of the hardware keyboard, the user can neither rest the hands by placing some fingers on some keys, nor perform a touch-typing operation. The user is required to touch a target key with a finger in the state in which the user positions the fingers of both hands above the touch-screen display. Consequently, in some cases, the load on the user's hands increases.

There is also known a virtual keyboard which is configured such that when the finger has been released from a certain key, a key code of this key is input by using as a trigger the release of the finger. However, in this kind of virtual keyboard, too, it is difficult to rest one or more fingers on keys. The reason for this is that when a finger lying on a certain key has been released from this key in order to touch a target key, the key code of the key, from which the finger has been released, may possibly be input.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view which illustrates the external appearance of an electronic apparatus according to an embodiment;

FIG. 2 is an exemplary view which illustrates a virtual keyboard which is displayed on a touch-screen display of the electronic apparatus of the embodiment;

FIG. 3 is an exemplary block diagram which illustrates a system configuration of the electronic apparatus of the embodiment;

FIG. 4 is an exemplary block diagram which illustrates the configuration of an input control program which is executed by the electronic apparatus of the embodiment;

FIG. 5 is an exemplary flow chart which illustrates the procedure of a keyboard process for controlling the virtual keyboard, which is executed by the electronic apparatus of the embodiment;

FIG. 6 is an exemplary flow chart which illustrates the procedure of an input determination process which is executed in the keyboard process of FIG. 5; and

FIG. 7 is an exemplary flow chart which illustrates the procedure of a mode switching process of effecting switching between a keyboard mode and a mouse mode, which is executed by the electronic apparatus of the embodiment.

### DETAILED DESCRIPTION

Various embodiments will be described hereinafter with reference to the accompanying drawings.

In general, according to one embodiment, an electronic apparatus includes a touch-screen display, a keyboard display module and a control module. The keyboard display module displays a virtual keyboard including a plurality of keys on the touch-screen display. The control module inputs a key code in accordance with a user operation on the virtual keyboard. The control module includes a detection module and an input control module. The detection module detects a plurality of first keys among the plurality of keys in response to contact between a plurality of first positions on the touch-screen display and external objects. The plurality of first keys correspond to the plurality of first positions.

The input control module determines whether a contact time from when the external object is put in contact with one of the plurality of first positions to when a contact state of the one of the plurality of first positions is released is shorter than a threshold time, in response to release of the contact state of the one of the plurality of first positions, executes an input process of inputting a key code associated with one of the plurality of first keys which corresponds to the one of the first positions when the contact time is shorter than the threshold time, and skips execution of the input process when the contact time is not shorter than the threshold time.

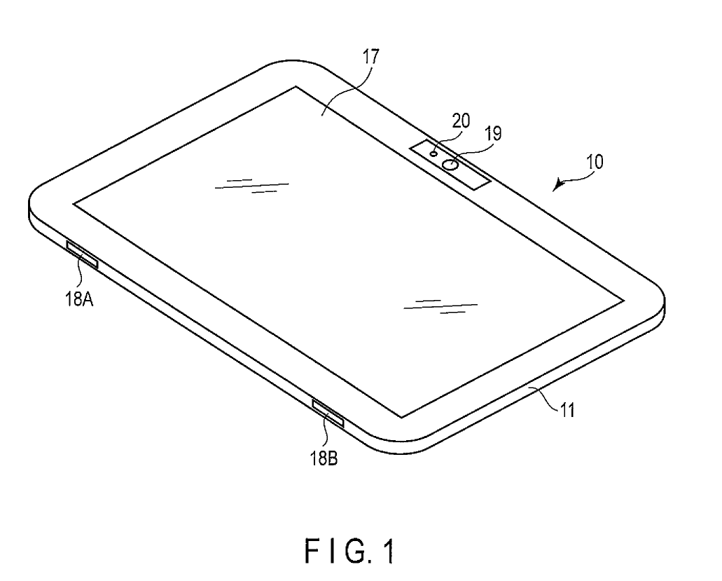

FIG. 1 is a perspective view which illustrates the external appearance of an electronic apparatus according to an embodiment. This electronic apparatus may be realized, for example, as a tablet-type personal computer (PC), a smart-phone or a PDA. In the description below, it is assumed that this electronic apparatus is realized as a tablet-type personal computer 10. As shown in FIG. 1, the tablet-type personal computer 10 is composed of a computer main body 11 and a touch-screen display 17.

The computer main body 11 has a thin box-shaped housing. A liquid crystal display (LCD) and a touch panel are built in the touch-screen display 17. The touch panel is provided in a manner to cover the screen of the LCD. The touch-screen display 17 is attached such that the touch-screen display 17 is laid over the top surface of the computer main body 11. The touch-screen display 17 can detect a position (also referred to as “touch position” or “contact position”) on the display screen, with which an external object (a pen or a finger of the hand) has been put in contact. This touch-screen display 17 supports a multi-touch function which enables simultaneous detection of a plurality of contact positions.

A camera 19 and a microphone 20 are disposed on the top surface of the computer main body 11. In addition, two speakers 18A and 18B are disposed on a side surface extending in a longitudinal direction of the computer main body 11.

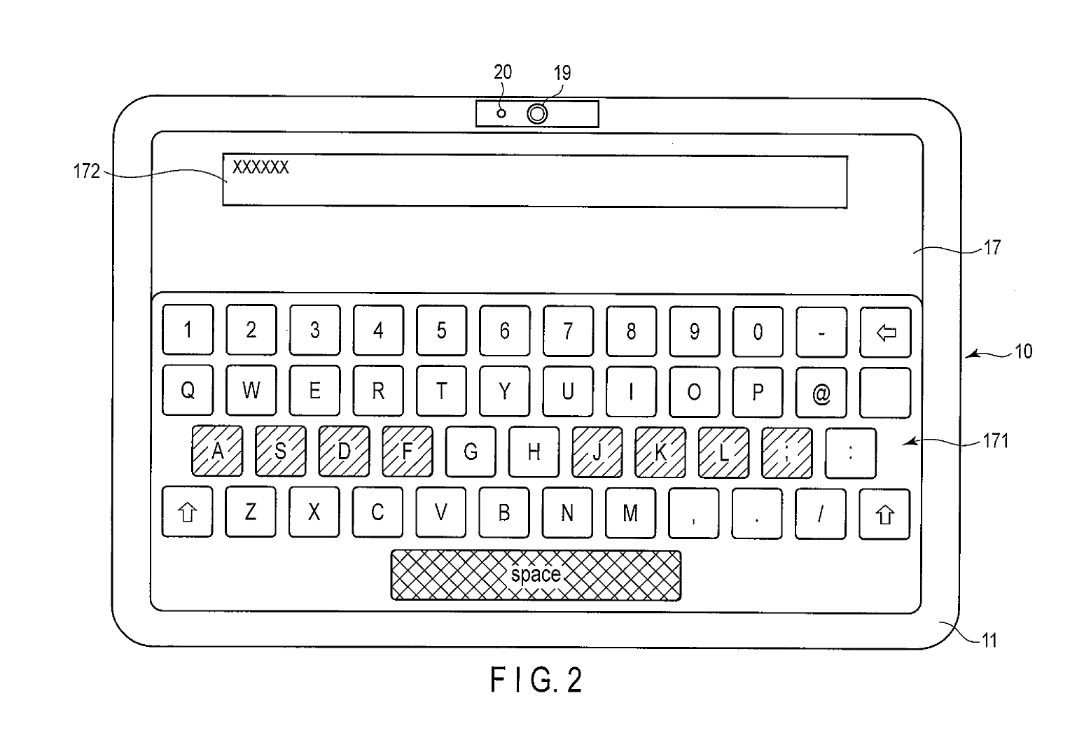

In the computer 10, the touch-screen display 17 is used as a main display for displaying screens of various application programs. Furthermore, as shown in FIG. 2, the touch-screen display 17 is used for displaying a virtual keyboard (also referred to as “software keyboard”) 171.

The direction of the display screen of the touch-screen display 17 can be switched between a vertical direction (portrait) and a horizontal direction (landscape). FIG. 2 shows the layout of the virtual keyboard 171 at a time of the landscape.

The virtual keyboard 171 includes a plurality of keys for inputting a plurality of key codes (e.g. a plurality of numeral keys, a plurality of alphabet keys, and a plurality of arrow keys). To be more specific, the virtual keyboard 171 includes a plurality of buttons (software buttons) corresponding to a plurality of keys. A character input area (text box) 172 for displaying a character corresponding to a key code, which is input by the operation of the virtual keyboard 171, may be displayed, together with the virtual keyboard 171, on the display screen of the touch-screen display 17.

In the present embodiment, there is provided a key input control function for enabling execution of a type input operation in a state in which one or more fingers of the user are placed on a key (keys) on the virtual keyboard 171, that is, in a state in which one or more fingers are put in contact with the touch-screen display 17. In the key input control function, determination as to whether a key has been input-operated or not is executed, not at a time instant when the key has been touched by, e.g. the finger, but at a time instant when the finger has been released from the key. In the state in which the user puts some fingers in contact with some keys, only a process of detecting such individual keys is executed. A key code input process is not executed unless the finger is released from the key.

Specifically, when a first position on the touch-screen display 17 has been touched by, e.g. a finger, the key input control function detects a key (first key) corresponding to the first position. In addition, if another position (second position) on the touch-screen display 17 has been touched by, e.g. another finger in the state in which the first position is touched by the finger, the key input control function detects a key (second key) corresponding to the second position. Furthermore, if still another position (third position) on the touch-screen display 17 has been touched by, e.g. another finger in the state in which the first position and second positions are touched by the fingers, the key input control function detects a key (third key) corresponding to the third position. A key input process or the like is not executed in the state in which the three fingers are put in contact with the first key, second key and third key.

When the contact between any one of the first position, second position and third position and the finger has been released, the key input control function executes a determination process for determining whether the operation (release operation) of releasing the contact is an input operation or not.

This determination process is executed based on information of at least one of, for example, a contact time, a touch impact degree, a contact pressure, a number of times of contact, and a contact position. The contact time is a time length from when a finger is put in contact with a certain key to when the contact between this key and the finger is released. In the determination process of this embodiment, this contact time is mainly used. The contact time corresponds to a time which is used for a touch-and-release operation (tap operation). The touch-and-release operation (tap operation) is an operation of touching a certain key by a finger and then releasing the finger from this key.

In the determination process, it is determined whether the contact time is shorter than a threshold time. If the contact time is shorter than the threshold time, an input process is executed for inputting a key code associated with the key whose contact with the finger has been released, that is, a key code associated with the key on which the touch-and-release operation has been executed. On the other hand, when the contact time is not shorter than the threshold time, the execution of the input process is skipped, and the key code associated with the key, on which the touch-and-release operation has been executed, is not input.

Thus, even if the user releases the finger, which has been placed on a certain key for resting, from this key in order to tap a target key, the key code of this released key is not input. The reason is that in many cases, the contact time of this released key is longer than the threshold time. In addition, while a finger is put on a certain key, a touch-and-release operation (tap operation) may be executed on another key by another finger. Thereby, a key code associated with this another key can normally be input.

Furthermore, since plural fingers can be placed in the home position, the above-described touch-typing operation can be performed.

The touch impact degree is indicative of an impact degree of an impact which is applied to the computer 10 by a touch-and-release operation (tap operation). In the present embodiment, not only the contact time but also the touch impact degree can be used for the input determination. On condition that the touch impact degree is greater than a threshold value, it is determined that an input operation has been executed. Thereby, even if the user's finger is temporarily put on a certain key in error, the input of the key code of this key can be prevented.

The contact pressure is a pressure of contact between a certain key and a finger. The larger the area where the finger is put in contact with the key, the greater the contact pressure. Accordingly, the use of the contact pressure for the input termination also makes it possible to prevent an erroneous input.

The number of times of contact is indicative of the number of times the same key has been successively tap-operated. Depending on the movement of a finger, it may possibly be erroneously determined that the same key has been successively tap-operated in a short time. When the number of times of contact is used for the input determination, such successive tap operations are treated as a single tap operation.

The contact position is indicative of a position where a tap operation has been executed. By using the contact position for the input termination, it is possible to determine whether a position on the touch-screen display 17, where a tap operation has been executed, is a position where a key is disposed. Thus, by using the contact position for the input determination, even if a tap operation is executed at a position other than the positions of disposition of keys, it is possible to prevent the occurrence of an erroneous input.

Besides, the key input control function of the present embodiment also executes a feedback control process for feeding back to the user the condition of an input operation on the virtual keyboard 171. In the feedback control process, a notification indicative of a current input operation condition is generated by using at least one of an image, a moving picture (animation), sound and vibration.

For example, when a certain key on the virtual keyboard 171 has been touched by a finger or the like, the color of the touched key is changed to a specific color (color 1) (in FIG. 2 a key whose color has been changed to color 1 is indicated by hatching). Thereby, the user can be notified that each touched key has been detected.

When the touched key is either of two specific keys (“F” key and “J” key) which are used for discriminating the home position, such feedback is executed that a specific sound is output. For example, when the “F” key has been touched by a finger or the like, certain sound (sound 1) is output. When the “J” key has been touched by a finger or the like, other sound (sound 2) is output. Alternatively, when the “F” key has been touched by a finger or the like, sound (sound 1) may be output from the left-side speaker 18A, and when the “J” key has been touched by a finger or the like, sound (sound 2) may be output from the right-side speaker 18B. In this case, sound 1 and sound 2 may be the same. In addition, instead of outputting sound, vibration may be generated.

When a key code of a certain key has been input by a touch-and-release operation (i.e. when the contact time is shorter than the threshold time), the color of this key is changed to a specific color (color 2) (in FIG. 2 a key whose color has been changed to color 2 is indicated by double-hatching). Meanwhile, each time a key code has been input, a sound, which is different from a sound that is produced when a key is touched, may be produced, or vibration, which is different from vibration that is generated when a key is touched, may be generated.

By the above-described feedback control process, the user can understand, even without looking at the touch-screen display 17, whether the key is touched or not, and also whether the fingers are placed on the keys corresponding to the home key position. Therefore, the touch-typing operation using the virtual keyboard 171 by the user can be supported.

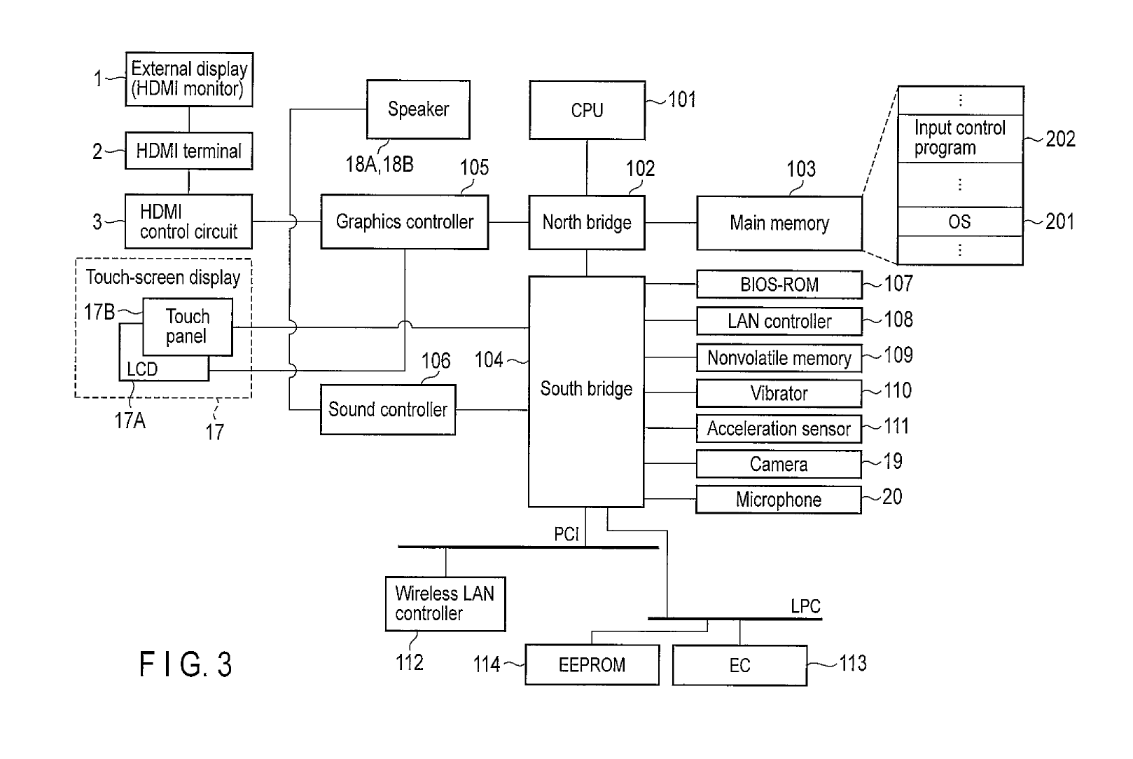

FIG. 3 shows the system configuration of the computer 10.

The computer 10, as shown in FIG. 3, includes a CPU 101, a north bridge 102, a main memory 103, a south bridge 104, a graphics controller 105, a sound controller 106, a BIOS-ROM 107, a LAN controller 108, a nonvolatile memory 109, a vibrator 110, an acceleration sensor 111, a wireless LAN controller 112, an embedded controller (EC) 113, an EEPROM 114, and an HDMI control circuit 3.

The CPU 101 is a processor for controlling the operation of the respective components of the computer 10. The CPU 101 executes an operating system (OS) 201 and various application programs, which are loaded from the nonvolatile memory 109 into the main memory 103. The application programs include an input control program 202. This input control program 202 is software for executing a key input process by using the above-described virtual keyboard 171, and is executed on the operating system (OS) 201.

Besides, the CPU 101 executes a BIOS that is stored in the BIOS-ROM 107. The BIOS is a program for hardware control.

The north bridge 102 is a bridge device which connects a local bus of the CPU 101 and the south bridge 104. The north bridge 102 includes a memory controller which access-controls the main memory 103. The north bridge 102 also has a function of communicating with the graphics controller 105 via, e.g. a PCI EXPRESS serial bus.

The graphics controller 105 is a display controller which controls an LCD 17A that is used as a display monitor of the computer 10. A display signal, which is generated by the graphics controller 105, is sent to the LCD 17A. The LCD 17A displays images, based on the display signal. A touch panel 17B is disposed on the LCD 17A. The touch panel 17B is a pointing device for executing an input on the screen of the LCD 17A. The user can operate, for example, a graphical user interface (GUI), which is displayed on the screen of the LCD 17A, by using the touch panel 17B. For example, by touching a button displayed on the screen, the user can instruct execution of a function corresponding to this button.

The HDMI terminal 2 is an external display connection terminal. The HDMI terminal 2 is capable of sending a non-compressed digital video signal and digital audio signal to an external display device 1 via a single cable. The HDMI control circuit 3 is an interface for sending a digital video signal to the external display device 1, which is called “HDMI monitor”, via the HDMI terminal 2. In short, the computer 10 can be connected to the external display device 1 via, e.g. the HDMI terminal 2.

The south bridge 104 controls devices on a PCI (Peripheral Component Interconnect) bus and devices on an LPC (Low Pin Count) bus. The south bridge 104 includes an ATA controller for controlling the nonvolatile memory 109.

The south bridge 104 includes a USB controller for controlling various USB devices. Further, the south bridge 104 has a function of communicating with the sound controller 106. The sound controller 106 is a sound source device and outputs audio data, which is a target of playback, to the speakers 18A and 18B. The LAN controller 108 is a wired communication device which executes wired communication of, e.g. the IEEE 802.3 standard. The wireless LAN controller 112 is a wireless communication device which executes wireless communication of, e.g. the IEEE 802.11 standard.

The EC 113 is a one-chip microcomputer including an embedded controller for power management. The EC 113 has a function of powering on/off the computer 10 in accordance with the user's operation of the power button.

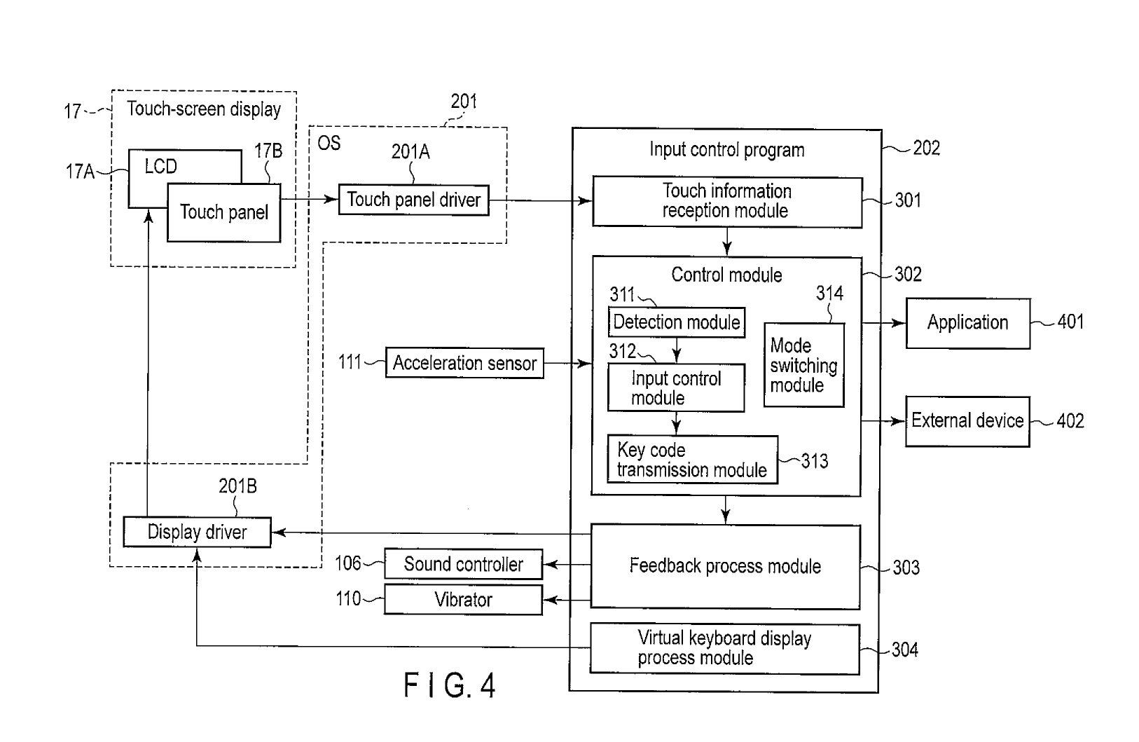

Next, referring to FIG. 4, the configuration of the key input control program 202 is described. The key input control program 202 includes a touch information reception module 301, a control module 302, a feedback process module 303 and a virtual keyboard display process module 304.

The touch information reception module 301 can receive, each time a touch event has occurred, information relating to the touch event which has occurred, from a touch panel driver 201A in the OS 201. The touch event means the following:

Event 1: the number of touches has increased (the touch-screen display 17 has been touched by the finger),

Event 2: the number of touches has decreased (the finger has been released from the touch-screen display 17), and

Event 3: the touch state has changed (the position of the finger has moved).

To be more specific, the touch event means a touch start event (event 1), a release event (event 2) and a movement event (event 3). The touch start event occurs when an external object has been put in contact with the touch-screen display 17. Specifically, the touch start event occurs when the number of positions (touch positions) on the touch-screen display 17, which are touched by the external object, has increased (i.e. when the touch-screen display 17 has been touched by the finger). The information of the touch start event includes coordinate information (x, y) of the touch position on the touch-screen display 17.

The release event occurs when the contact between the touch-screen display 17 and the external object has been released. Specifically, the release event occurs when the number of positions (touch positions) on the touch-screen display 17, which are touched by the external object, has decreased (i.e. when the finger has been released from the touch-screen display 17). The information of the release event includes coordinate information (x, y) of the touch position, from which the finger has been released.

The movement event occurs when the coordinates of the touch position on the touch-screen display 17 has changed, for example, when the finger has moved while the finger is in contact with the touch-screen display 17. The information of the movement event includes coordinate information (x, y) of the destination position of movement of the touch position.

The control module 302 has two operation modes, namely a keyboard mode and a mouse mode. The keyboard mode is an operation mode in which a key code is input in accordance with a user operation on the virtual keyboard 171. The mouse mode is an operation mode in which relative coordinate data indicative of a direction and distance of movement of a contact position on the touch-screen display 171 is output in accordance with the movement of the contact position.

The control module 302 includes a detection module 311, an input control module 312 and a key code transmission module 313, as functional modules for executing the keyboard mode.

The detection module 311 detects each of currently touched keys in accordance with a touch start event (an increase in the number of touches) and a movement event (a change in touch state). To be more specific, responding to the contact between a plurality of first positions of the touch-screen display 17 and external objects (a plurality of fingers), the detection module 311 detects a plurality of keys (a plurality of first keys) on the virtual keyboard 171, which correspond to the plural first positions.

The input control module 312 executes the above-described input determination process in accordance with a release event, etc. To be more specific, responding to the release of the contact state of any one of the plural first positions, the input control module 312 determines whether the contact time, from when the external object is put in contact with the one of the first positions to when the contact state of the one of the first positions is released, is shorter than the threshold time.

When the contact time is shorter than the threshold time, the input control module 312 executes an input process for inputting a key code which is associated with the one of the plural first keys, which corresponds to the one of the first positions. In this case, the key code is input to, e.g. an application program 401 which is executed by the computer 10. When the contact time is not shorter than the threshold time, the input control module 312 skips the execution of this input process.

In the input determination process, not only the contact time, but also the touch impact degree, etc. may be used, as described above. The touch impact degree can be detected by the acceleration sensor 111. In addition, the touch impact degree may be detected by using the magnitude of sound which is input by the microphone 20. Responding to the release of contact between any one of first positions and the external object, the input control module 312 determines whether the touch impact degree detected by the acceleration sensor 111 or the like is greater than the threshold value. When the touch impact degree is not greater than the threshold value, the input control module 312 skips the execution of the input process.

The key code transmission module 313 transmits an input key code to an external device 402. In this case, the input key code is wirelessly transmitted to the external device 402 via a communication module (e.g. a wireless communication device such as wireless LAN controller 112) which communicates with the external device 402. The external device 402 is an electronic device such as a TV. By the key code transmission module 313, the computer 10 can be made to function as an input device for inputting data (key code) to the external device 402. The function of transmitting the key code to the external device 402 has effects when text is input to, e.g. a search window displayed on the TV.

Further, the control module 302 includes a mode switching module 314. The mode switching module 314 switches the operation mode of the control module 302 between the above-described keyboard mode and mouse mode. Responding to the establishment of contact between two positions on the touch-screen display 17 and the external objects, the mode switching module 314 determines whether the distance between these two positions is shorter than a threshold distance. The threshold distance may be set to be shorter than a distance (key pitch) between two neighboring keys.

If the distance between the two positions is shorter than the threshold distance, the mode switching module 314 switches the operation mode of the control module 302 from the keyboard mode to the mouse mode. For example, by touching two neighboring points on the touch-screen display 17 by two fingers, the user can switch the operation mode from the keyboard mode to the mouse mode. The user can move a cursor or the like on the screen, by moving the touch positions of the two fingers on the touch-screen display 17.

In the mouse mode, if a tap operation is performed by one of the two fingers (e.g. the left-side finger), the control module 302 inputs an event indicative of a left click to the application program 401, or transmits an event indicative of a left click to the external device 402. In addition, in the mouse mode, if a tap operation is performed by the other of the two fingers (e.g. the right-side finger), the control module 302 inputs an event indicative of a right click to the application program 401, or transmits an event indicative of a right click to the external device 402.

In the mouse mode, if the number of fingers, which are in contact with the touch-screen display 17, becomes zero, the mode switching module 314 terminates the mouse mode. In this case, the mode switching module 314 may restore the operation mode of the control module 302 to the above-described keyboard mode.

The feedback process module 303 executes the above-described feedback control process by using the sound controller 106, vibrator 110, a display driver 201B in the OS 201, etc. The virtual keyboard display process module 304 displays the virtual keyboard 171 on the touch-screen display 17.

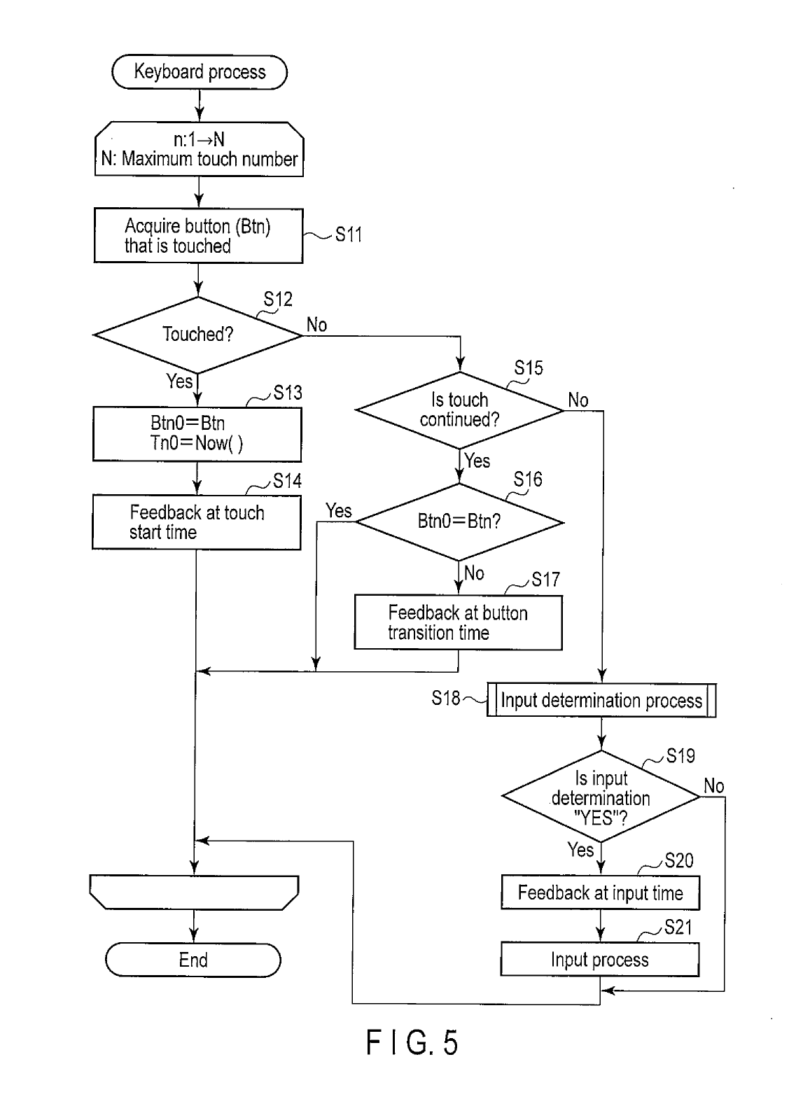

Next, referring to a flow chart of FIG. 5, a description is given of an example of the procedure of a keyboard process which is executed by the input control program 202.

The procedure of the keyboard process of FIG. 5 is executed, for example, each time a touch event (touch start event, release event, movement event) has occurred. In the flow chart of FIG. 5, a maximum touch number N is indicative of the current number of touches. At a time when a touch start event has occurred, the maximum touch number N is the number of touches immediately after the touch start event has occurred. At a time when a release event has occurred, the maximum touch number N is the number of touches immediately before the release event has occurred.

When the touch event has occurred, that is, when any one of the touch start event, release event and movement event has occurred, the input control program 202 executes the following process with respect to each of keys (buttons) which are currently being touched.

At first, based on coordinates of each of touch positions on the touch-screen display 17, the input control program 202 detects each of the keys (buttons) which are being touched. Different identifiers Btn (n=1˜N) are allocated to the detected keys (buttons). The following process is executed on each of the detected keys.

To start with, the input control program 202 acquires a button (Btn) that is a target of processing (step S11), and determines whether this button (Btn) that is the target of processing is a newly touched button or not (step S12). When a touch start event has occurred and the coordinates of a touch position indicated by this touch start event agree with the coordinates of the button (Btn) that is the target of processing, it can be determined that the button (Btn) that is the target of processing is a newly touched button. If the button (Btn) is a newly touched button (YES in step S12), the input control program 202 stores a key code or a key identification number of the button (Btn) in a variable Btn0 corresponding to the button (Btn), and stores a present time as a touch start time in a variable Tn0 corresponding to the button (Btn) (step S13). Then, the input control program 202 executes such a feedback process as displaying the newly touched button in a specific color (step S14). Then, a process for a button that is the next target of processing is started.

If the button (Btn) that is the target of processing is not a newly touched button (NO in step S12), the input control program 202 determines whether the button (Btn) that is the target of processing is a button which is being touched or a button which has been released (step S15). The state in which the button (Btn) that is the target of processing is being touched corresponds to a state in which the finger stays on the touch position, or a state in which the finger has moved to a position corresponding to another key while the finger is being in contact with the touch-screen display 17. The released button is a button corresponding to a position where the finger has been released. When a release event has occurred and the coordinates of a touch position indicated by this release event agree with the coordinates of the button (Btn) that is the target of processing, it can be determined that the button (Btn) that is the target of processing is a released button.

If the button (Btn) that is the target of processing is a button in a state in which the button is being touched (YES in step S15), the input control program 202 determines whether the button (Btn) that is the target of processing is a button which has already been touched and is currently being touched, that is, a button corresponding to the touch position on which the finger is placed (step S16). In step S16, the input control program 202 determines whether the key code of the button (Btn) that is the target of processing agrees with the key code that is already stored in the variable Btn0 corresponding to the button (Btn) that is the target of processing. If these key codes agree, it is determined that the button (Btn) that is the target of processing is a button corresponding to the touch position on which the finger is placed (YES in step S16). In this case, the input control program 202 advances to the process of the button that is the next target of processing.

On the other hand, if these key codes do not agree, it is determined that the button (Btn) that is the target of processing is a button corresponding to the touch position at the destination of movement of the finger (NO in step S16). In this case, the input control program 202 executes a feedback process such as changing the color of the button (Btn) that is the target of processing, i.e. the button at the destination of movement, and changes the variable Btn0, which corresponds to the button (Btn) that is the target of processing, to the key code of the button at the destination of movement (step S17). There is no need to update the value of the variable Tn0 corresponding to the button (Btn) that is the target of processing. This aims at preventing the execution of a key input due to the movement of the finger. Then, the process of the button that is the next target of processing is started.

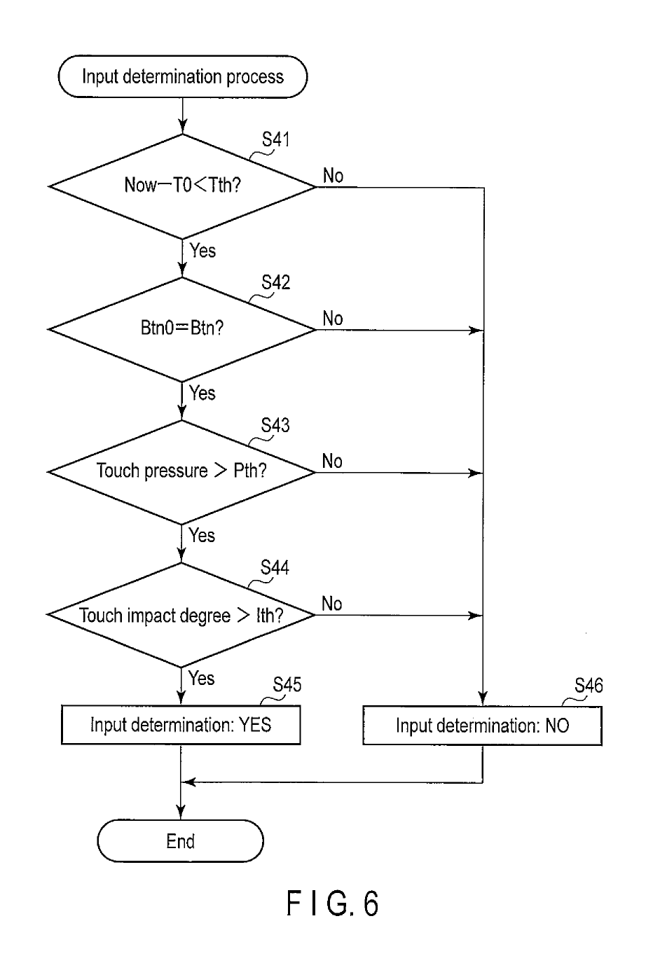

If the button (Btn) that is the target of processing is a released button (NO in step S15), the input control program 202 executes an input determination process for determining whether the release operation of the button (Btn) that is the target of processing is an input operation or not, based on, e.g. the contact time of the button (Btn) that is the target of processing (step S18). The procedure of this input determination process will be described later with reference to a flow chart of FIG. 6.

When it is determined that the release operation of the button (Btn) that is the target of processing is an input operation (YES in step S19), the input control program 202 generates a notification of the execution of the input operation, by using a change of the key color, sound or vibration (step S20), and inputs the key code that is stored in the variable Btn0 corresponding to the button (Btn) that is the target of processing (step S21). In step S21, a character corresponding to the key code, which is associated with the button (Btn) that is the target of processing, is displayed in the text box 172. Alternatively, the key code, which is associated with the button (Btn) that is the target of processing, is transmitted to the external device 402, and a character corresponding to the key code, which is associated with the button (Btn) that is the target of processing, is displayed on the screen of the external device 402. Then, the process of the button that is the next target of processing is started.

When it is not determined that the release operation of the button (Btn) that is the target of processing is an input operation (NO in step S19), the input control program 202 skips the execution of the process of steps S20 and S21, and transitions to the process of the button that is the next target of processing. In the meantime, when it is not determined that the release operation is an input operation, the input control program 202 may generate a notification indicating that the input operation has not been executed (the skip of the input process), by using a change of the key color, sound or vibration.

A first use case is now assumed that the user taps, for instance, a “K” key by a finger (middle finger) while placing another finger (index finger) on a certain key (e.g. “J” key). In this case, a touch start event occurs responding to the contact between the “J” key and the index finger, and the “J” key is detected by the process of steps S12 and S13. If the middle finger comes in contact with the “K” key in the state in which the index finger is in contact with the “J” key, a touch start event occurs once again, and the “K” key is further detected by the process of steps S12 and S13.

A release event occurs when the middle finger of the right hand has been released from the “K” key. In this case, it is determined, by the process of steps S18 and S19, whether the contact time of the “K” key, from which the finger has been released, is shorter than the threshold time. If the contact time of the “K” key is shorter than the threshold time, the input process of the “K” key is executed.

The case is now assumed that the user has released the index finger of the right hand from the “J” key, for example, in order to tap a “U” key. In this case, a release event occurs, and it is determined whether the contact time of the “J” key, from which the finger has been released, is shorter than the threshold time. In this case, usually, the contact time of the “J” key exceeds the threshold time. Accordingly, the input process of the “J” key is not executed.

As has been described above, in the present embodiment, while a finger is placed on a certain key, another key is tapped by another finger. Thereby, a key code associated with this another key can normally be input. In addition, even if the user releases the finger, which is placed on this certain key for resting, from this key, in order to tap a target key, a key code of the key, from which the finger has been released, is not input.

Next, a second use case is assumed that the fingers of both hands of the user are placed in the home position, that is, the little finger, ring finger, middle finger and index finger of the left hand are placed on the “A” key, “S” key, “D” key and “F” key, and the index finger, middle finger, ring finger and little finger of the right hand are placed on the “J” key, “K” key, “L” key and “;” key. In this case, some (eight at maximum) touch start events occur, and eight keys (“A” key, “S” key, “D” key, “F” key, “J” key, “K” key, “L” key and “;” key) corresponding to eight contact positions on the touch-screen display 17 are detected. In addition, with respect to each key, the time of the instant, at which the key is touched, is detected.

The case is now assumed that the user has released the index finger of the right hand from the “J” key, for example, in order to tap a “U” key. In this case, a release event occurs, and it is determined whether the contact time of the “J” key from which the finger has been released (i.e. the time from when the “J” key was touched to when the “J” key has been released) is shorter than the threshold time. Usually, the contact time of the “J” key exceeds the threshold time. Accordingly, the input process of the “J” key is not executed.

Then, responding to the contact between the “U” key and the index finger of the right hand, a contact start event occurs, and the “U” key is detected. Further, the time when the “U” key was touched is detected. Immediately thereafter, the contact between the “U” key and the index finger of the right hand is released. In this case, a release event occurs, and it is determined whether the contact time of the “U” key, from which the finger has been released, is shorter than the threshold time. If the contact time of the “U” key is shorter than the threshold time, the input process of the “U” key is executed.

In this manner, in the present embodiment, the type input operation can be performed in the state in which a plurality of fingers are placed in the home position.

Next, referring to a flow chart of FIG. 6, an example of the procedure of the input determination process is described.

The input control program 202 determines whether the contact time of a released button is shorter than a threshold time (step S41). In step S41, the input control program 202 subtracts a time (a time at which the button was touched), which is stored in the variable Tn0 corresponding to the released button, from the present time, thereby calculating a contact time (Now−T0). Then, the input control program 202 determines whether the contact time (Now−T0) is shorter than a threshold time Th.

If the contact time is shorter than the threshold time (YES in step S41), the input control program 202 determines whether the key code of the released button (Btn) agrees with the key code that is already stored in the variable Btn0 corresponding to this button (Btn) (step S42). This determination is executed in order to reconfirm that the released button (Btn) is a touched-and-released button.

If the key code of the released button (Btn) agrees with the key code that is already stored in the variable Btn0 corresponding to this button (Btn) (YES in step S42), the input control program 202 determines whether a contact pressure (touch pressure) corresponding to the released button (Btn) is greater than a threshold Pth (step S43).

If the contact pressure (touch pressure) corresponding to the released button (Btn) is greater than the threshold Pth (YES in step S43), the input control program 202 determines whether a touch impact degree (e.g. a touch impact degree corresponding to a period immediately before the occurrence of the release event) is greater than a threshold Ith (step S44). The touch impact degree is used in order to determine whether the touch-screen display 17 has been touched in such a manner that the touch-screen display 17 is tapped by the finger (“tap operation”). When the finger has erroneously been put in contact with the touch-screen display 17, the touch impact degree is a low value. Thus, by using the touch impact degree for the input determination, the possibility of an erroneous input can be decreased.

The acceleration sensor 111 can be used for the calculation of the touch impact degree. If the touch-screen display 17 is tapped by the finger, variation amounts ΔX, ΔY and ΔZ of the acceleration in three axes X, Y and Z increase instantaneously. The value of the root of the sum of square values of ΔX, ΔY and ΔZ can be calculated as a value of the touch impact value.

The built-in microphone 20 may be used as a sensor for detecting the touch impact degree. If the touch-screen display 17 is tapped by the finger, a sound, which is captured by the built-in microphone 20, becomes a pulse-like sound. The frequency characteristic of the pulse-like sound is that the power from low frequencies to high frequencies instantaneously rises and instantaneously falls. Thus, by analyzing a signal of sound captured by the built-in microphone 20, the touch impact degree is calculated.

Besides, the touch impact degree may be calculated by using both the acceleration sensor 111 and built-in microphone 20. In this case, the value of the touch impact degree can be calculated by a linear sum between a value obtained by the acceleration sensor 111 and a value obtained by analyzing the signal of sound. In the case where environmental noise is large, a linear sum weight for sound may be decreased in the calculation of the touch impact value.

If the touch impact degree is greater than the threshold Ith (YES in step S44), the input control program 202 determines that the release operation of the button (Btn) that is the target of processing is an input operation (step S45). On the other hand, if any one of the four conditions corresponding to steps S41 to S44 fails to be satisfied, the input control program 202 determines that the release operation of the button (Btn) that is the target of processing is not an input operation (step S46).

By using, in addition to the contact time, both the touch pressure and the touch impact degree for the input determination, an erroneous input can efficiently be prevented. In the meantime, the input termination may be executed by using only the contact time, or by using the contact time and touch impact degree, or by using the contact time and touch pressure.

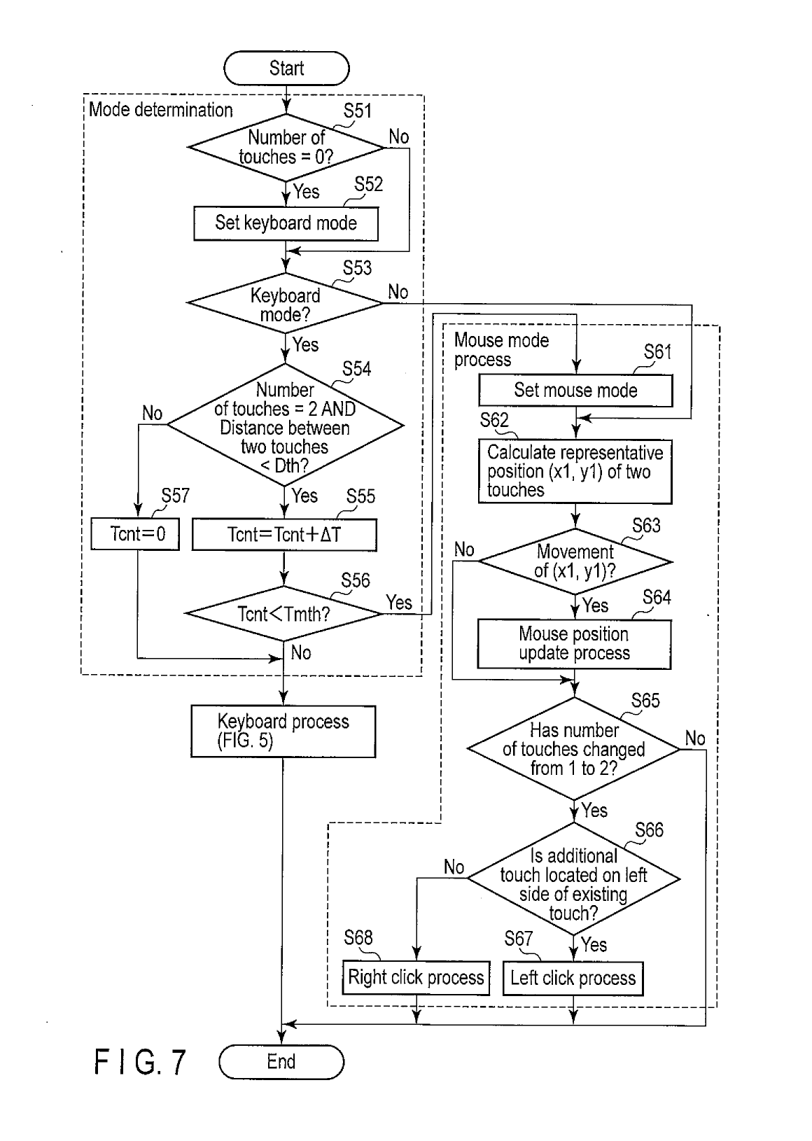

Next, referring to a flow chart of FIG. 7, a description is given of an example of the procedure of a mode determination process and a mouse process, which are executed by the input control program 202. The mode determination process is a process for effecting switching between the keyboard mode and the mouse mode.

The mode determination process is executed, for example, each time a touch event (touch start event, release event, movement event) has occurred.

When a touch event has occurred, that is, when any one of a touch start event, a release event and a movement event has occurred, the input control program 202 detects the current number of touches, i.e. the number of currently touched keys, and determines whether the current number of touches is zero or not.

If the current number of touches is zero (YES in step S51), the input control program 202 sets the operation mode thereof to be the keyboard mode (step S52). If the current number of touches is not zero (NO in step S51), the process of step S52 is skipped.

Then, the input control program 202 determines whether the present operation mode is the keyboard mode or not (step S53). If the present operation mode is the keyboard mode (YES in step S53), the input control program 202 determines whether a condition that the current number of touches is 2 and the distance between the two touch positions is shorter than a threshold distance Dth is established or not (step S54).

If the condition that the current number of touches is 2 and the distance between the two touch positions is shorter than the threshold distance Dth is not established (NO in step S54), the input control program 202 initializes the variable Tcnt to zero (step S57), and executes the keyboard process which has been described with reference to FIG. 5.

On the other hand, if the condition that the current number of touches is 2 and the distance between the two touch positions is shorter than the threshold distance Dth is established (YES in step S54), the input control program 202 determines whether these two touch positions have been touched substantially at the same time (steps S55 and S56). In step S55, the input control program 202 calculates a difference (ΔT) between times (touch start times) at which the two touch positions were touched, respectively, and substitutes a sum between the difference (ΔT) and the present variable Tcnt for the variable Tcnt. The present variable Tcnt is set at zero. Accordingly, the variable Tcnt is indicative of the difference (ΔT). In step S56, the input control program 202 determines whether the variable Tcnt is shorter than a threshold time Tmth or not.

If the variable Tcnt is not shorter than the threshold time Tmth (NO in step S56), the input control program 202 executes the keyboard process which has been described with reference to FIG. 5. If the variable Tcnt is shorter than the threshold time Tmth (YES in step S56), the input control program 202 sets the operation mode thereof to be the mouse mode (step S61). In this case, in order to notify the user that the present operation mode is the mouse mode, it is possible to display an image, produce sound or generate vibration.

In the mouse mode, the input control program 202 calculates a representative position (x1, y1) of the two touch positions. The representative position (x1, y1) may be a middle position between the two touch positions. In accordance with the movement of the representative position (x1, y1) on the touch-screen display 17, the input control program 202 outputs relative coordinate data which is indicative of a distance and direction of movement of the representative position (x1, y1) (steps S63 and S64). In step S63, the input control program 202 determines whether the representative position (x1, y1) on the touch-screen display 17 has been moved. If the representative position (x1, y1) has been moved (YES in step S63), the input control program 202 advances to step S64. Then, in order to move the position of the mouse cursor on the screen, the input control program 202 inputs relative coordinate data indicative of movement distances in the X direction and Y direction. In step S64, a process is executed for moving the mouse cursor in accordance with the input relative coordinate data. In the meantime, when the target of control is the external device 402, the relative coordinate data is transmitted to the external device 402, and the mouse cursor on the screen of the external device 402 is moved.

Subsequently, the input control program 202 determines whether an operation corresponding to a left click or an operation corresponding to a right click has been executed (steps S64 to S68). In the present embodiment, it is determined whether the touch-screen display 17 has been re-touched by one of the two fingers which are in contact with the touch-screen display 17, and the re-touch operation is detected as an operation corresponding to a left click or an operation corresponding to a right click.

In the case of performing an operation of re-touching the touch-screen display 17 by one of the two fingers which are in touch with the touch-screen display 17, the number of touches temporarily changes from 2 to 1, and immediately thereafter the number of touches changes from 1 to 2. In this embodiment, the change of the number of touches from 1 to 2 is detected as an operation corresponding to a left click or a right click.

Specifically, the input control program 202 determines whether the number of touches has changed from 1 to 2 (step S65). If the number of touches has changed from 1 to 2 (YES in step S65), the input control programs 202 determines whether an additional touch position (new touch position) is located on the left side or the right side of the existing touch position (step S66). If the additional touch position is located on the left side of the existing touch position (YES in step S66), the input control program 202 executes a process of inputting an event indicative of a left click (step S67). Incidentally, when the target of control is the external device 402, the event indicative of the left click is transmitted to the external device 402.

If the additional touch position is located on the right side of the existing touch position (NO in step S66), the input control program 202 executes a process of inputting an event indicative of a right click (step S68). When the target of control is the external device 402, the event indicative of the right click is transmitted to the external device 402.

The mouse mode is continued until the number of touches becomes zero. Thus, once a transition has occurred to the mouse mode, even if the number of touch positions changes to 1, the mouse cursor can be moved in accordance with the movement of the single touch position. In this case, this single touch position may be used as the above-described representative position.

As has been described above, according to the present embodiment, responding to the contact between a plurality of first positions on the touch-screen display 17 and external objects, a plurality of first keys in the virtual keyboard 171, which correspond to the plurality of first positions on the touch-screen display 17, are detected. Then, responding to the release of the contact state of one of the plural first positions, it is determined whether the contact time, from when the external object is put in contact with the one of the first positions to when the contact state of the one of the first positions is released, is shorter than the threshold time. If the contact time is shorter than the threshold time, the input process is executed for inputting the key code associated with one of the plural first keys, which corresponds to the one of the first positions.

Accordingly, in the case where the user has executed, while placing a finger (or fingers) on one or more first keys, a touch-and-release operation (tap operation) on another first key by another finger or the like, the key code associated with this another first key can normally be input. Furthermore, after the user has executed the touch-and-release operation of the another first key, even if the user releases the finger, which rests on a certain first key, from this certain first key in order to tap a certain target key, the key code of this released first key is not input.

Thus, in the state in which plural fingers are in contact with the touch-screen display 17, a type input operation can be performed. Therefore, the key input can easily be executed by using the touch-screen display 17. Moreover, the tablet computer 10 can be used as an input device for operating some other device such as a TV.

All the process procedures of the embodiment can be executed by software. Thus, the same advantageous effects as with the present embodiment can easily be obtained simply by installing a program, which executes the process procedures, into an ordinary computer including a touch-screen display through a computer-readable storage medium which stores the program, and executing the program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a touch-screen display;
a keyboard display module configured to display on the touch-screen display a virtual keyboard comprising a plurality of keys; and
a controller configured to input a key code in accordance with a user operation on the virtual keyboard,
the controller comprising:
a detection module configured to detect a plurality of first keys among the plurality of keys in response to contact between a plurality of first positions on the touch-screen display and an external object, the plurality of first keys corresponding to the plurality of first positions; and
an input control module configured to:
determine whether a contact time from when the external object contacts one of the plurality of first positions to when the external object releases contact with the one of the plurality of first positions is shorter than a threshold time,
when the contact time is shorter than the threshold time, execute an input process for a key code associated with one of the plurality of first keys corresponding to the one of the plurality of first positions, and
when the contact time is not shorter than the threshold time, skip execution of the input process.

2. The electronic apparatus of claim 1,
wherein the plurality of keys include two specific keys for discriminating a home key position, and
wherein the electronic apparatus further comprises a first feedback module configured to generate a notification indicating that the external object contacted a position corresponding to the home key position when the one of the plurality of first keys is one of the two specific keys.

3. The electronic apparatus of claim 2, further comprising a second feedback control module configured to generate a notification indicating that the input process has been executed.

4. The electronic apparatus of claim 3, wherein the second feedback control module is configured to generate a notification indicating that the input process has been skipped.

5. The electronic apparatus of claim 1, further comprising a sensor configured to detect an impact degree of an impact applied to the electronic apparatus,
wherein the input control module is configured to further determine whether the impact degree detected by the sensor is greater than a first threshold value, and configured to skip execution of the input process when the impact degree detected is less than the first threshold value.

6. The electronic apparatus of claim 1, wherein the input control module is configured to further determine whether a contact pressure between the one of the plurality of first positions and the external object is greater than a second threshold value, and configured to skip execution of the input process when the contact pressure is less than the second threshold value.

7. The electronic apparatus of claim 1, further comprising:
a communication module configured to communicate with an external device; and
a key code transmission module configured to transmit the key code to the external device via the communication module.

8. The electronic apparatus of claim 1, further comprising a mode switching module configured to determine whether a distance between two contact positions by the external object on the touch-screen display is shorter than a threshold distance, and configured to switch, when the distance between the two contact positions is shorter than the threshold distance, an operation mode of the input control module from a virtual keyboard input mode for inputting a key code in accordance with a user operation on the virtual keyboard to a mouse input mode for inputting relative coordinate data which is indicative of a direction and distance of movement of a contact position in accordance with movement of the contact position on the touch-screen display, the contact position being a position touched by the external object.

9. The electronic apparatus of claim 1, further comprising a feedback control module configured to generate a notification indicating that the input process has been executed.

10. The electronic apparatus of claim 9, wherein the feedback control module is configured to generate a notification indicating that the input process has been skipped.

11. The electronic apparatus of claim 5, wherein the input control module is configured to further determine whether a contact pressure between the one of the plurality of first positions and the external object is greater than a second threshold value, and configured to skip execution of the input process when the contact pressure is less than the second threshold value.

12. An input method for an electronic apparatus comprising a touch-screen display, comprising:
displaying on the touch-screen display a virtual keyboard comprising a plurality of keys;
detecting a plurality of first keys among the plurality of keys in response to contact between a plurality of first positions on the touch-screen display and an external object, the plurality of first keys corresponding to the plurality of first positions;
determining whether a contact time from when the external object contacts one of the plurality of first positions to when the external object releases contact with the one of the plurality of first positions is shorter than a threshold time, in response to the external object releasing contact with the one of the plurality of first positions, and
when the contact time is shorter than the threshold time, executing an input process of inputting a key code associated with one of the plurality of first keys corresponding to the one of the plurality of first positions; and
when the contact time is not shorter than the threshold time, skipping execution of the input process.

13. A computer-readable, non-transitory storage medium having stored thereon a program, the program causing a computer comprising a touch-screen display to:
display on the touch-screen display a virtual keyboard comprising a plurality of keys;
detect a plurality of first keys among the plurality of keys in response to contact between a plurality of first positions on the touch-screen display and an external object, the plurality of first keys corresponding to the plurality of first positions;
determine whether a contact time from when the external object contacts one of the plurality of first positions to when the external device releases contact with the one of the plurality of first positions is shorter than a threshold time;
when the contact time is shorter than the threshold time, execute an input process for a key code associated with one of the plurality of first keys corresponding to the one of the plurality of first positions; and
when the contact time is not shorter than the threshold time, skip execution of the input process.
